(19) United States
(12) Patent Application Publication
(10) Pub. No.: US 2025/0377879 A1
(43) Pub. Date: Dec. 11, 2025

(54) MANAGING UPDATES AT A CLIENT INFORMATION HANDLING SYSTEM

(71) Applicant: Dell Products L.P., Round Rock, TX (US)

(72) Inventors: Anup Keshwani, Bangalore (IN); Jyothi Bandakka Nanjappa, Bangalore (IN); Gokul Thiruchengode Vajravel, Bangalore (IN); Mahesh Sayibabu, Bangalore (IN)

(21) Appl. No.: 18/735,406

(22) Filed: Jun. 6, 2024

(51) Int. Cl. G06F 8/65

(52) U.S. Cl. CPC G06F 8/65

(57) ABSTRACT

Managing updates at a client information handling system, including receiving user input indicating an update to an operating system (OS) at a client information handling system; in response to receiving the user input: detecting i) a type of the OS at the client information handling system and ii) computer-implemented applications at the client information handling system; determining that the type of the OS corresponds to a type of the update to the OS, and in response, identifying, from a data store and for each computer-implemented application, an equivalent computer-implemented application that is associated with the type of the update to the OS; creating a unified image including i) the update to the OS and ii) the equivalent computer-implemented applications; providing the unified image to the client information handling system; and applying the unified image at the client information handling system, including upgrading the OS and installing the equivalent computer-implemented applications.

### BACKGROUND

### Field of the Disclosure

The disclosure relates generally to an information handling system, and in particular, managing updates at a client information handling system.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Regular OS upgrades are crucial for maintaining system security, performance, and compatibility. OS upgrades can provide bug fixes, security patches, and new features. Failing to upgrade can leave your system vulnerable to security threats. Managing OS upgrades across many computers in an enterprise setting can be complex. IT administrators balance the need for timely upgrades with potential disruptions to productivity.

### SUMMARY

Innovative aspects of the subject matter described in this specification may be embodied in a method of managing updates at a client information handling system, including receiving, at a server information handling system in communication with the client information handling system, user input indicating an update to an operating system (OS) at the client information handling system; in response to receiving the user input: detecting i) a type of the OS at the client information handling system and ii) one or more computer-implemented applications at the client information handling system; determining that the type of the OS at the client information handling system corresponds to a type of the update to the OS; in response to determining that the type of the OS at the client information handling system corresponds to the type of the update to the OS, identifying, from a data store and for each computer-implemented application at the client information handling system, an equivalent computer-implemented application that is associated with the type of the update to the OS; creating a unified image including i) the update to the OS and ii) the equivalent computer-implemented applications; providing the unified image to the client information handling system; and applying the unified image at the client information handling system, including upgrading the OS at the client information handling system and installing the equivalent computer-implemented applications at the client information handling system.

Other embodiments of these aspects include corresponding systems, apparatus, and computer programs, configured to perform the actions of the methods, encoded on computer storage devices.

These and other embodiments may each optionally include one or more of the following features. For instance, the equivalent computer-implemented applications are updated versions of the respective computer-implemented applications. The equivalent computer-implemented applications are web-based versions of the respective computer-implemented applications. Determining that the type of the OS at the client information handling system does not correspond to the type of the update of the OS, the type of the update of the OS including a different OS; in response to determining that the type of the OS at the client information handling system does correspond to the type of the update to the OS, identifying, from the data store and for each computer-implemented application at the client information handling system, a similar computer-implemented application that is associated with the type of the update to the OS; creating a unified image including i) the update to the OS and ii) the similar computer-implemented applications; providing the unified image to the client information handling system; and applying the unified image at the client information handling system, including installing the new OS at the client information handling system and installing the similar computer-implemented applications at the client information handling system. The similar computer-implemented applications are updated versions of the respective computer-implemented applications. The equivalent computer-implemented applications are web-based versions of the respective computer-implemented applications.

Particular implementations of the subject matter described in this specification can be implemented so as to realize one or more of the following advantages. For example, OS upgrades across multiple information handling systems can be handled using a single deployment image without adding any additional steps in existing IT admin OS/image upgrade workflows. For example, such OS upgrades are scalable across platforms, operating system types, and application types.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of a computing environment for managing updates at a client information handling system.

FIG. 3 illustrates a swim-lane diagram for managing updates at a client information handling system.

FIG. 4 illustrates a method for managing updates at a client information handling system.

### DESCRIPTION OF PARTICULAR EMBODIMENT(S)

This disclosure discusses methods and systems for managing updates at a client information handling system. In short, updates to an operating system and/or computer-implemented applications are vital for seamless migration for consumers. There are ITDMs who upgrade multiple information handling systems from OS to another OS; or upgrade the OS to a new version of the OS. Each client information handling system can have a different set of computer-implemented applications to be installed along with the base OS. For example, such installation scenarios can include 1) upgrade of the OS with the same application type but different application versions; 2) upgrade of the OS with different applications; 3) new/different OS upgrade with the same application type; and 4) new/different OS upgrade with differing application versions. A server information handling system can generate a single image for upgrade at the client information handling system, described further herein.

Specifically, this disclosure discusses a system and a method for managing updates at a client information handling system, including receiving, at a server information handling system in communication with the client information handling system, user input indicating an update to an operating system (OS) at the client information handling system; in response to receiving the user input: detecting i) a type of the OS at the client information handling system and ii) one or more computer-implemented applications at the client information handling system; determining that the type of the OS at the client information handling system corresponds to a type of the update to the OS; in response to determining that the type of the OS at the client information handling system corresponds to the type of the update to the OS, identifying, from a data store and for each computer-implemented application at the client information handling system, an equivalent computer-implemented application that is associated with the type of the update to the OS; creating a unified image including i) the update to the OS and ii) the equivalent computer-implemented applications; providing the unified image to the client information handling system; and applying the unified image at the client information handling system, including upgrading the OS at the client information handling system and installing the equivalent computer-implemented applications at the client information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

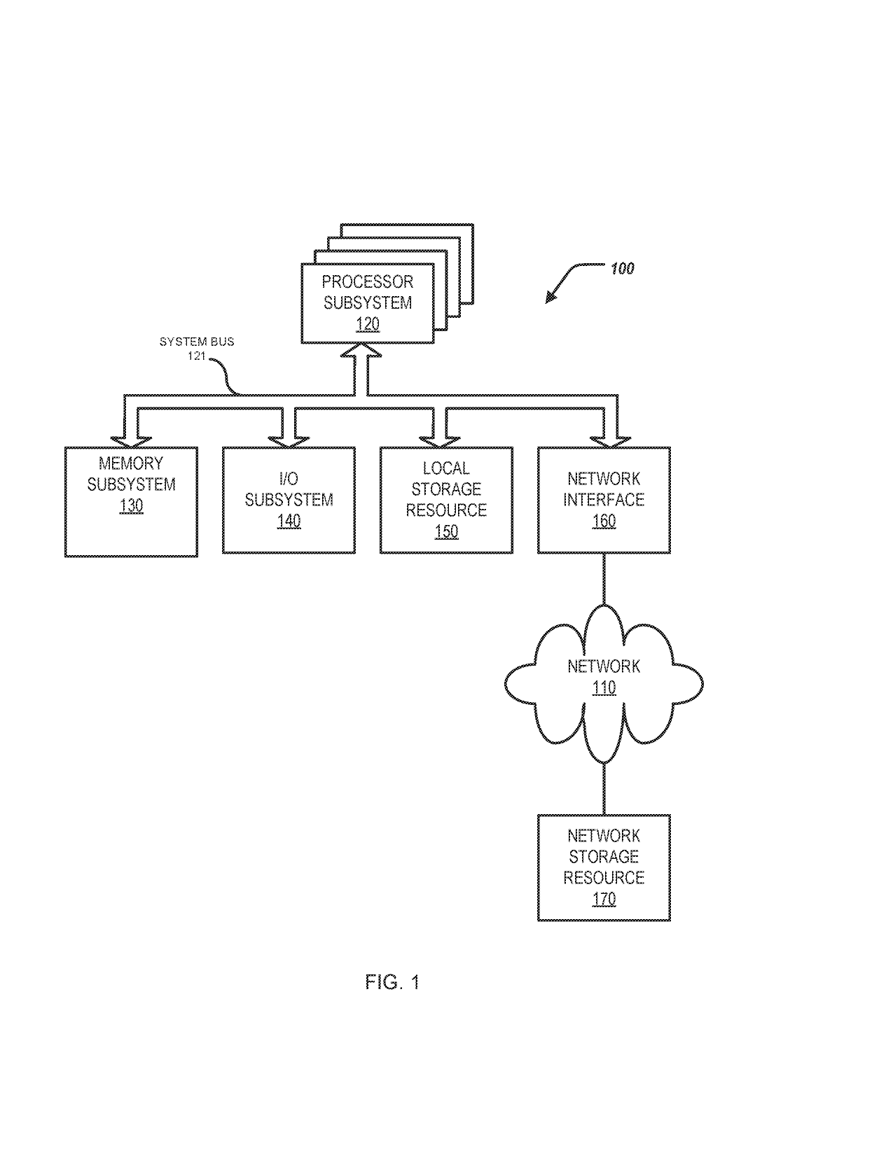

Particular embodiments are best understood by reference to FIGS. 1-4 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as display devices, head mounted displays, head mounted display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

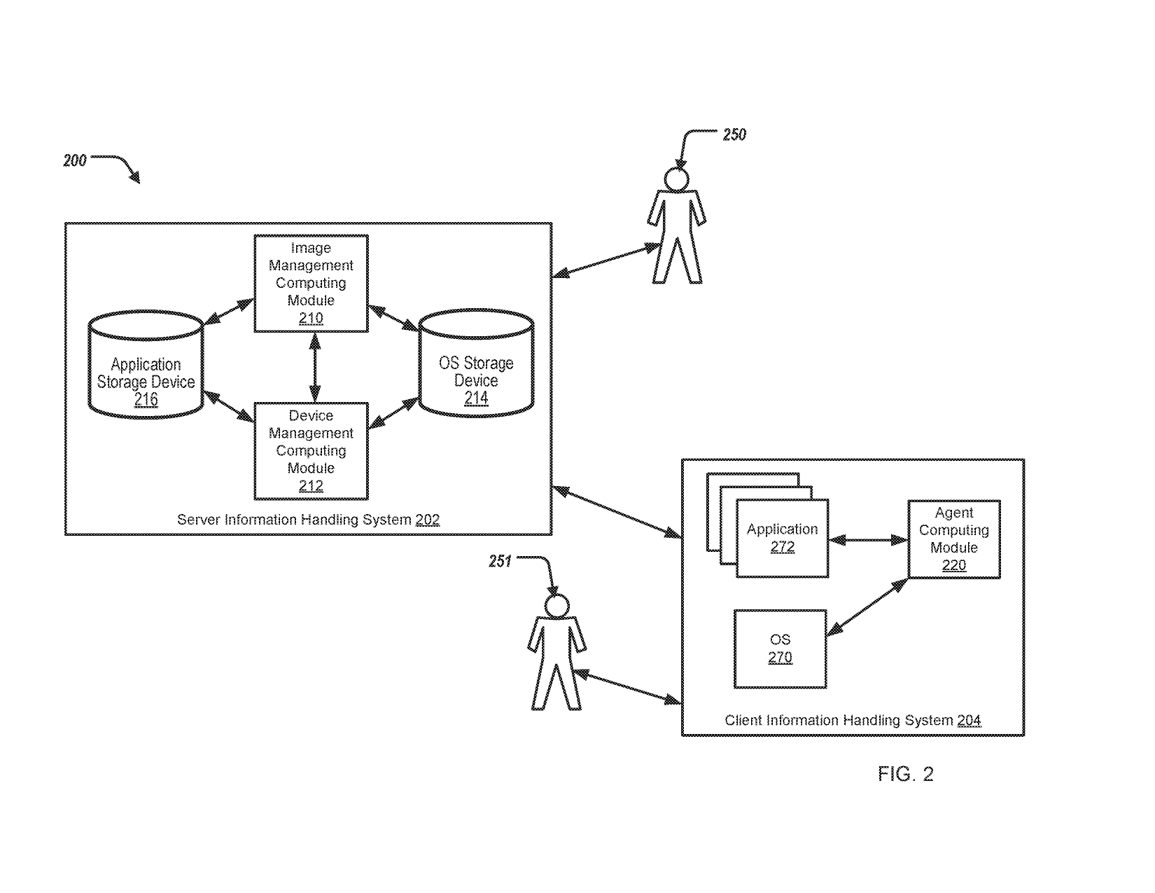

Turning to FIG. 2, FIG. 2 illustrates an environment 200 including a server information handling system 202 and a client information handling system 204. The server information handling system 202 can include an image management computing module 210, a device management computing module 212, an operating system (OS) storage device 214 (or OS data store 214), and an application (app) storage device 216 (or application data store 216). In some examples, the server information handling system 202 is similar to, or includes, the information handling system 100 of FIG. 1. The client information handling system 204 can include an agent management computing module 220. In some examples, the client information handling system 202 is similar to, or includes, the information handling system 100 of FIG. 1.

The OS storage device 214 can store data including multiple OS, multiple versions of each OS, and the like. The application data store 216 can store data including multiple computer-implemented applications, updates to each of the multiple computer-implemented applications, multiple versions of each of the multiple computer-implemented applications, and the like.

An operating system (OS) 270 can execute at the client information handling system 204 (the client information handling system 204 is associated with the OS 270; the client information handling system 204 executes the OS 270). Furthermore, computer-implemented applications 272 can execute at the client information handling systems 204 (the client information handling system 204 is associated with the computer-implemented applications 272; the client information handling system 204 executes the computer-implemented applications 272). The computer-implemented applications 272 can additionally be referred to as computer-executable applications 272; computer-language applications 272; programming language computer-executable applications 272; and the like.

The server information handling system 202 can be in communication with the client information handling system 204 (e.g., over a network, the “Internet”). For example, the agent computing module 220 can establish a session with the device management computing module 212.

A user (Information Technology Decision Maker (ITDM)) 250 can interact with and provide user input to the server information handling system 202. A user (end-user) 251 can interact with and provide user input to the client information handling system 204.

In short, updates to the OS 270 and/or computer-implemented applications 272 are vital for seamless migration for consumers (such as user 251). There are ITDMs who upgrade multiple information handling systems from OS to another OS; or upgrade the OS to a new version of the OS. Each client information handling system can have a different set of computer-implemented applications to be installed along with the base OS. For example, such installation scenarios can include 1) upgrade of the OS with the same application type but different application versions; 2) upgrade of the OS with different applications; 3) new/different OS upgrades with the same application type; and 4) new/different OS upgrades with differing application versions. The server information handling system 202 can generate a single image for upgrade at the client information handling system 204, described further herein.

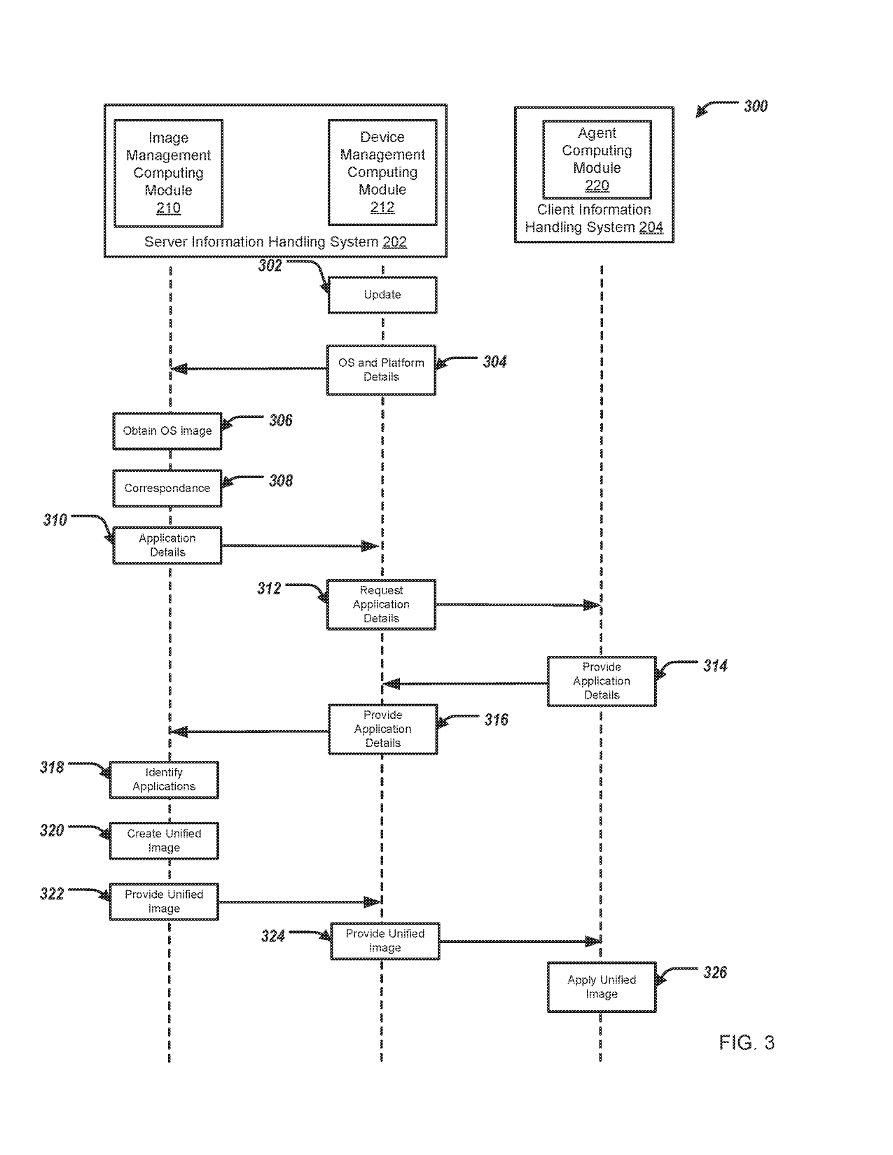

FIG. 3 illustrates a swim-lane diagram depicting selected elements of an embodiment of a method 300 for managing updates at a client information handling system. The method 300 may be performed by the information handling system 100, the server information handling system 202, the image management computing module 210, the device management computing module 212, the client information handling system 204, and/or the agent computing module 220, and with reference to FIGS. 1-2. It is noted that certain operations described in method 300 may be optional or may be rearranged in different embodiments.

The server information handling system 202, and in particular, the device management computing module 212, can receive user input indicating an update to the OS 270 at the client information handling system 202, at 302. In response to receiving the user input indicating the update, the device management computing module 212 provides details regarding the OS 270 and platform details of the client information handling system 204 to the image management computing module 210, at 304. Specifically, when the agent computing module 220 establishes a session with the device management computing module 212, the agent computing module 220 can provide the details regarding the OS 270 and platform details of the client information handling system 204 to the device management computing module 212. The agent computing module 220 can establish the session with the device management computing module 212 prior to the update.

The image management computing module 210 can obtain an OS image of the update, at 306. Specifically, the image management computing module 210 obtains the OS image of the update from the OS storage device 214. The image management computing module 210 obtains the OS image of the update from the OS storage device 214 that corresponds to the user input, and in particular, corresponds to the update information provided by the user input.

The image management computing module 210 can determine a correspondence between the type of the OS 270 at the client information handling system 204 and the type of the update to the OS, at 308. In some examples, the image management computing module 210 can determine that the type of the OS 270 at the client information handling system 204 corresponds to the type of the update to the OS. For example, both the OS 270 and the update can be of a same “type” of OS. For example, the OS 270 can be OS type1 and the update can be OS type 1.1. For example, the OS 270 can be Windows 10 and the update can be Windows 11.

The image management computing module 210, in response to determining that the type of the OS 270 at the client information handling system 204 corresponds to the type of the update to the OS, detects the computer-implemented applications 272 at the client information handling system 204. Specifically, the image management computing module 210 provides a request to the device management computing module 212 for details of the computer-implemented applications 272, at 310. The device management computing module 212 can request details of the computer-implemented applications 272 from the agent computing module 220, at 312; and receive such details of the computer-implemented applications 272 from the agent computing module 220, at 314. The device management computing module 212 can forward/provide the details of the computer-implemented applications 272 to the image management computing module 210, at 316. In some examples, the details of the computer-implemented applications 272 can include, for each computer-implemented application 272, a name of the application, a version of the application (version number), publisher details of the application (such as publisher name), certificate publisher, owner name, and the like.

In short, the server information handling system 202, in response to receiving the user input, can detect i) a type of the OS 270 at the client information handling system 204 and ii) the computer-implemented applications 272 at the client information handling system 204.

The image management computing module 210, further in response to determining that the type of the OS 270 at the client information handling system 204 corresponds to the type of the update to the OS, identifies, from the application storage device 216 and for each computer-implemented application 272, an equivalent computer-implemented application that is associated with the type of the update to the OS, at 318. Specifically, the image management computing module 210 accesses the application storage device 216 and identifies, for each computer-implemented application 272, an equivalent computer-implemented application that is i) associated with the computer-implemented application 272 and ii) associated with the type of the update to the OS.

In some examples, the equivalent computer-implemented applications are updated versions of the respective computer-implemented applications 272. For example, when a type of the OS 270 at the client information handling system 204 corresponds to the type of the update to the OS (the OS 270 and the update to the OS are the same type with the update to the OS being a newer version of the OS 270), the image management computing module 210 identifies, from the application storage device 216 and for each computer-implemented application 272, an equivalent computer-implemented application that is of the same type as the computer-implemented application 272 and an updated version of the computer-implemented application 272. For example, when the OS 270 is Windows 10 and the update to the OS 270 is a Windows 11 upgrade, the image management computing module 210 identifies, for a computer-implemented application 272 of Adobe PDF (native application), an updated version of Adobe PDF from the application storage device 216 that corresponds to the update to the OS 270 (corresponds to a Windows 11 upgrade).

In some examples, the equivalent computer-implemented applications are web-based versions of the respective computer-implemented applications. For example, when a type of the OS 270 at the client information handling system 204 corresponds to the type of the update to the OS (the OS 270 and the update to the OS are the same type with the update to the OS being a newer version of the OS 270), the image management computing module 210 identifies, from the application storage device 216 and for each computer-implemented application 272, an equivalent computer-implemented application that is of the same type as the computer-implemented application 272 and a web-based version of the computer-implemented application 272. For example, when the OS 270 is Windows 10 and the update to the OS 270 is a Windows 11 upgrade, the image management computing module 210 identifies, for a computer-implemented application 272 of Adobe PDF (native application), a web-version of Adobe PDF from the application storage device 216 (e.g., PDF webreader) that corresponds to the update to the OS 270 (corresponds to a Windows 11 upgrade).

In some examples, image management computing module 210, further in response to determining that the type of the OS 270 at the client information handling system 204 corresponds to the type of the update to the OS, identifies, from the application storage device 216 and for each computer-implemented application 272, an equivalent computer-implemented application that is associated with the type of the update to the OS utilizing machine learning (ML). That is, the image management computing module 210 can implement a machine learning (ML) model (neural networks, recurrent neural network (RNN), and the like) to identify the equivalent computer-implemented applications (native applications, web applications, store applications, and the like).

The image management computing module 210 can create a unified image, at 320. Specifically, the image management computing module 210 can create the unified image to include i) the update to the OS 270, and ii) the equivalent computer-implemented applications. The unified image is a single image for the client information handling system 204 that includes both i) the update to the OS 270, and ii) the equivalent computer-implemented applications.

The image management computing module 210 provides the unified image to the device management computing module 212, at 322. The device management computing module 212 forwards/provides the unified image to the agent computing module 220 at the client information handling system 204, at 324. The agent computing module 220 applies the unified image at the client information handling system 204, at 326. Specifically, the agent computing module 220 applies the unified image by upgrading the OS 270 (with the OS upgrade) at the client information handling system 204 and installing the equivalent computer-implemented applications at the client information handling system 204. That is, the device management computing module 212 establishes a session with the agent computing module 220 to provide the unified image to the agent computing module 220, and the agent computing module 220 installs the OS upgrade and the equivalent computer-implemented applications at the client information handling system 204. For example, the agent computing module 220 can install the OS upgrade of Windows 11 (from Windows 10) and the equivalent computer-implemented applications (updated version of native application or web-version of the native application).

As mentioned above, the image management computing module 210 can determine a correspondence between the type of the OS 270 at the client information handling system 204 and the type of the update to the OS, at 308. In some examples, the image management computing module 210 can determine that the type of the OS 270 at the client information handling system 204 does correspond to the type of the update to the OS. For example, the OS 270 and the update can be of a different “type” of OS. For example, the OS 270 can be OS type1 and the update can be OS type 2. For example, the OS 270 can be Ubuntu 24 and the update can be Windows 11.

The image management computing module 210, in response to determining that the type of the OS 270 at the client information handling system 204 does not correspond to the type of the update to the OS, detects the computer-implemented applications 272 at the client information handling system 204. Specifically, the image management computing module 210 provides a request to the device management computing module 212 for details of the computer-implemented applications 272, at 310. The device management computing module 212 can request details of the computer-implemented applications 272 from the agent computing module 220, at 312; and receive such details of the computer-implemented applications 272 from the agent computing module 220, at 314. The device management computing module 212 can forward/provide the details of the computer-implemented applications 272 to the image management computing module 210, at 316. In some examples, the details of the computer-implemented applications 272 can include, for each application 272, a name of the application, a version of the application (version number), publisher details of the application (such as publisher name), certificate publisher, owner name, and the like.

In short, the server information handling system 202, in response to receiving the user input, can detect i) a type of the OS 270 at the client information handling system 204 and ii) the computer-implemented applications 272 at the client information handling system 204.

The image management computing module 210, further in response to determining that the type of the OS 270 at the client information handling system 204 does not correspond to the type of the update to the OS, identifies, from the application storage device 216 and for each computer-implemented application 272, a similar computer-implemented application that is associated with the type of the update to the OS, at 318. Specifically, the image management computing module 210 accesses the application storage device 216 and identifies, for each computer-implemented application 272, a similar computer-implemented application that is i) associated with the computer-implemented application 272 and ii) associated with the type of the update to the OS.

In some examples, the similar computer-implemented applications are updated versions of the respective computer-implemented applications 272. For example, when a type of the OS 270 at the client information handling system 204 does not correspond to the type of the update to the OS (the OS 270 and the update to the OS are differing types with the update to the OS being a new/different OS than the OS 270), the image management computing module 210 identifies, from the application storage device 216 and for each computer-implemented application 272, a similar computer-implemented application that is of the same type as the computer-implemented application 272 and an updated version of the computer-implemented application 272. For example, when the OS 270 is Ubuntu 24 and the update to the OS 270 is Windows 11, the image management computing module 210 identifies, for a computer-implemented application 272 of Linux native PDF reader, an updated version of Windows Native Adobe PDF from the application storage device 216 that corresponds to the update to the OS 270 (corresponds to a Windows 11 upgrade).

In some examples, the similar computer-implemented applications are web-based versions of the respective computer-implemented applications. For example, when a type of the OS 270 at the client information handling system 204 does not correspond to the type of the update to the OS (the OS 270 and the update to the OS are differing types with the update to the OS being a new/different OS than the OS 270), the image management computing module 210 identifies, from the application storage device 216 and for each computer-implemented application 272, a similar computer-implemented application that is of the same type as the computer-implemented application 272 and a web-based version of the computer-implemented application 272. For example, when the OS 270 is Ubuntu 24 and the update to the OS 270 is Windows 11, the image management computing module 210 identifies, for computer-implemented application 272 of Linux native PDF reader, a web-version of Adobe PDF from the application storage device 216 that corresponds to the update to the OS 270 (corresponds to a Windows 11 upgrade).

In some examples, image management computing module 210, further in response to determining that the type of the OS 270 at the client information handling system 204 does not correspond to the type of the update to the OS, identifies, from the application storage device 216 and for each computer-implemented application 272, a similar computer-implemented application that is associated with the type of the update to the OS utilizing machine learning (ML). That is, the image management computing module 210 can implement a machine learning (ML) model (neural networks, recurrent neural network (RNN), and the like) to identify the similar computer-implemented applications (native applications, web applications, store applications, and the like).

The image management computing module 210 can create a unified image, at 320. Specifically, the image management computing module 210 can create the unified image to include i) the update to the OS 270, and ii) the similar computer-implemented applications. The unified image is a single image for the client information handling system 204 that includes both i) the update to the OS 270, and ii) the similar computer-implemented applications.

The image management computing module 210 provides the unified image to the device management computing module 212, at 322. The device management computing module 212 forwards/provides the unified image to the agent computing module 220 at the client information handling system 204, at 324. The agent computing module 220 applies the unified image at the client information handling system 204, at 326. Specifically, the agent computing module 220 applies the unified image by upgrading the OS 270 (with the OS upgrade) at the client information handling system 204 and installing the similar computer-implemented applications at the client information handling system 204. That is, the device management computing module 212 establishes a session with the agent computing module 220 to provide the unified image to the agent computing module 220, and the agent computing module 220 installs the OS upgrade and the similar computer-implemented applications at the client information handling system 204. For example, the agent computing module 220 can install the new OS of Windows 11 (from Ubuntu 24) and the similar computer-implemented applications (corresponding version of the native application or web-version of the native application).

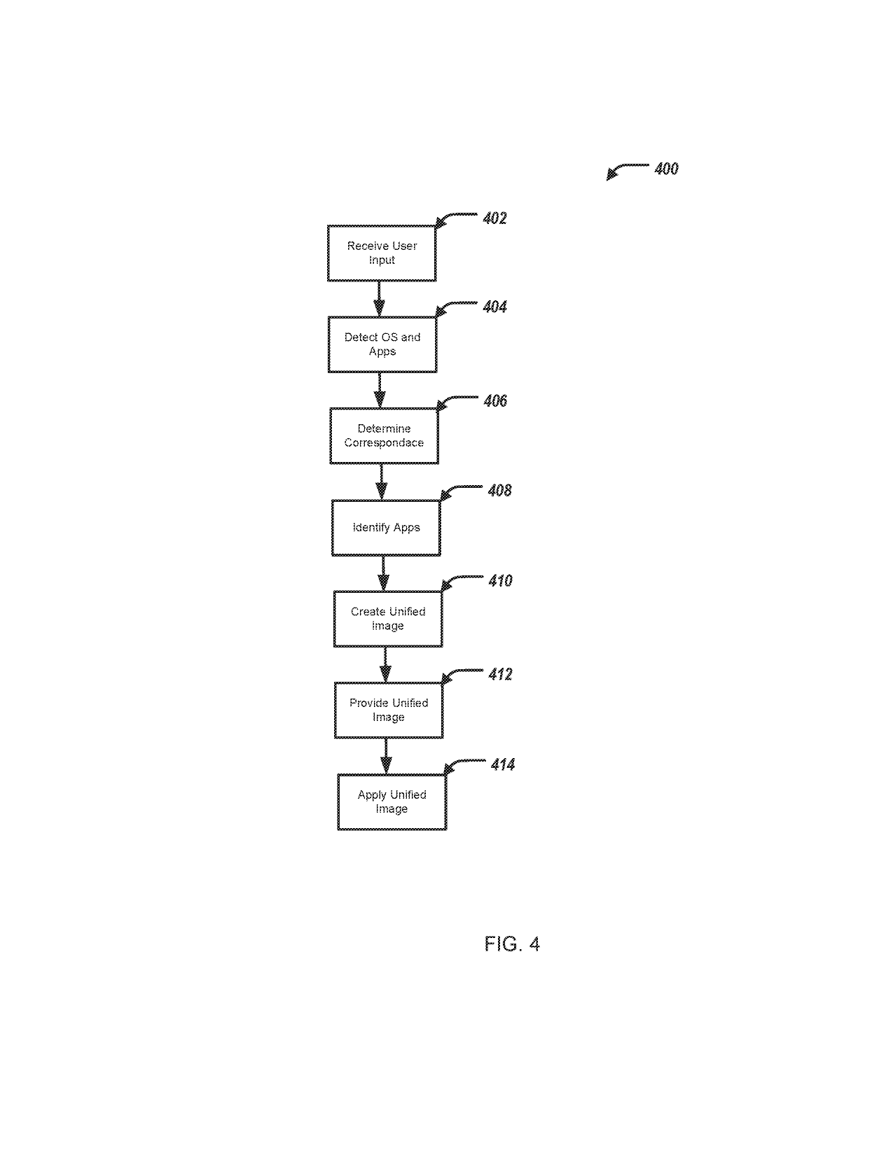

FIG. 4 illustrates a flowchart depicting selected elements of an embodiment of a method 400 for managing updates at a client information handling system. The method 400 may be performed by the information handling system 100, the server information handling system 202, the image management computing module 210, the device management computing module 212, the client information handling system 204, and/or the agent computing module 220, and with reference to FIGS. 1-2. It is noted that certain operations described in method 400 may be optional or may be rearranged in different embodiments.

The server information handling system 202 receives user input indicating an update to the OS 270 at the client information handling system 204, at 402. The server information handling system 202 detects i) a type of the OS 270 at the client information handling system 204 and ii) one or more computer-implemented applications 272 at the client information handling system 204, at 404. The server information handling system 202 determines a correspondence between the type of the OS 270 at the client information handling system 204 and a type of the update to the OS, at 406. In some examples, the server information handling system 202 determines that the type of the OS 270 at the client information handling system 204 corresponds to a type of the update to the OS. In some examples, the server information handling system 202 determines that the type of the OS 270 at the client information handling system 204 does not correspond to a type of the update to the OS. The server information handling system 202, identifies, from the OS storage device 214 and for each computer-implemented application 272 at the client information handling system 204, a corresponding computer-implemented application that is associated with the type of the update to the OS, at 408. In some examples, the server information handling system 202, when the type of the OS 270 at the client information handling system 204 corresponds to a type of the update to the OS, identifies, for each computer-implemented application 272 at the client information handling system 204, an equivalent computer-implemented application that is associated with the type of the update to the OS. In some examples, the server information handling system 202, when the type of the OS 270 at the client information handling system 204 does not correspond to a type of the update to the OS, identifies, for each computer-implemented application 272 at the client information handling system 204, a similar computer-implemented application that is associated with the type of the update to the OS. The server information handling system 202 creates a unified image including i) the update to the OS and ii) the corresponding computer-implemented applications, at 410. The server information handling system 202 provides the unified image to the client information handling system 204, at 412. The client information handling system 204 applies the unified image at the client information handling system 204, at 414. In some examples, applying the unified image can include upgrading the OS at the client information handling system 204 and installing the equivalent computer-implemented applications at the client information handling system 204.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing updates at a client information handling system, the method including:
receiving, at a server information handling system in communication with the client information handling system, user input indicating an update to an operating system (OS) at the client information handling system;
in response to receiving the user input:
detecting i) a type of the OS at the client information handling system and ii) one or more computer-implemented applications at the client information handling system;
determining that the type of the OS at the client information handling system corresponds to a type of the update to the OS;
in response to determining that the type of the OS at the client information handling system corresponds to the type of the update to the OS, identifying, from a data store and for each computer-implemented application at the client information handling system, an equivalent computer-implemented application that is associated with the type of the update to the OS;
creating a unified image including i) the update to the OS and ii) the equivalent computer-implemented applications;
providing the unified image to the client information handling system; and
applying the unified image at the client information handling system, including upgrading the OS at the client information handling system and installing the equivalent computer-implemented applications at the client information handling system.

2. The computer-implemented method of claim 1, wherein the equivalent computer-implemented applications are updated versions of the respective computer-implemented applications.

3. The computer-implemented method of claim 1, wherein the equivalent computer-implemented applications are web-based versions of the respective computer-implemented applications.

4. The computer-implemented method of claim 1, further including:
determining that the type of the OS at the client information handling system does not correspond to the type of the update of the OS, the type of the update of the OS including a different OS;
in response to determining that the type of the OS at the client information handling system does correspond to the type of the update to the OS, identifying, from the data store and for each computer-implemented application at the client information handling system, a similar computer-implemented application that is associated with the type of the update to the OS;
creating a unified image including i) the update to the OS and ii) the similar computer-implemented applications;
providing the unified image to the client information handling system; and
applying the unified image at the client information handling system, including installing the new OS at the client information handling system and installing the similar computer-implemented applications at the client information handling system.

5. The computer-implemented method of claim 4, wherein the similar computer-implemented applications are updated versions of the respective computer-implemented applications.

6. The computer-implemented method of claim 4, wherein the equivalent computer-implemented applications are web-based versions of the respective computer-implemented applications.

7. A computing environment, including:
a server information handling system comprising a processor having access to memory media storing instructions executable by the processor to perform operations, comprising:
receiving, at the server information handling system in communication with a client information handling system, user input indicating an update to an operating system (OS) at the client information handling system;
in response to receiving the user input:
detecting i) a type of the OS at the client information handling system and ii) one or more computer-implemented applications at the client information handling system;
determining that the type of the OS at the client information handling system corresponds to a type of the update to the OS;
in response to determining that the type of the OS at the client information handling system corresponds to the type of the update to the OS, identifying, from a data store and for each computer-implemented application at the client information handling system, an equivalent computer-implemented application that is associated with the type of the update to the OS;
creating a unified image including i) the update to the OS and ii) the equivalent computer-implemented applications;
providing the unified image to the client information handling system; and
the client information handling system comprising a processor having access to memory media storing instructions executable by the processor to perform operations, comprising:
applying the unified image at the client information handling system, including upgrading the OS at the client information handling system and installing the equivalent computer-implemented applications at the client information handling system.

8. The computing environment of claim 7, wherein the equivalent computer-implemented applications are updated versions of the respective computer-implemented applications.

9. The computing environment of claim 7, wherein the equivalent computer-implemented applications are web-based versions of the respective computer-implemented applications.

10. The computing environment of claim 1,
wherein the server information handling system is further configured to perform operations:
determining that the type of the OS at the client information handling system does not correspond to the type of the update of the OS, the type of the update of the OS including a different OS;
in response to determining that the type of the OS at the client information handling system does correspond to the type of the update to the OS, identifying, from the data store and for each computer-implemented application at the client information handling system, a similar computer-implemented application that is associated with the type of the update to the OS;
creating a unified image including i) the update to the OS and ii) the similar computer-implemented applications;
providing the unified image to the client information handling system; and
wherein the client information handling system is further configured to perform operations:
. the unified image at the client information handling system, including installing the new OS at the client information handling system and installing the similar computer-implemented applications at the client information handling system.

11. The computing environment of claim 10, wherein the similar computer-implemented applications are updated versions of the respective computer-implemented applications.

12. The computing environment of claim 10, wherein the equivalent computer-implemented applications are web-based versions of the respective computer-implemented applications.

13. A non-transitory computer-readable medium storing software comprising instructions executable by one or more computers which, upon such execution, cause the one or more computers to perform operations comprising:
receiving, at a server information handling system in communication with the client information handling system, user input indicating an update to an operating system (OS) at the client information handling system;
in response to receiving the user input:
detecting i) a type of the OS at the client information handling system and ii) one or more computer-implemented applications at the client information handling system;
determining that the type of the OS at the client information handling system corresponds to a type of the update to the OS;
in response to determining that the type of the OS at the client information handling system corresponds to the type of the update to the OS, identifying, from a data store and for each computer-implemented application at the client information handling system, an equivalent computer-implemented application that is associated with the type of the update to the OS;
creating a unified image including i) the update to the OS and ii) the equivalent computer-implemented applications;
providing the unified image to the client information handling system; and
applying the unified image at the client information handling system, including upgrading the OS at the client information handling system and installing the equivalent computer-implemented applications at the client information handling system.

14. The computer-implemented method of claim 13, wherein the equivalent computer-implemented applications are updated versions of the respective computer-implemented applications.

15. The computer-implemented method of claim 13, wherein the equivalent computer-implemented applications are web-based versions of the respective computer-implemented applications.

16. The computer-implemented method of claim 13, the operations further including:
determining that the type of the OS at the client information handling system does not correspond to the type of the update of the OS, the type of the update of the OS including a different OS;
in response to determining that the type of the OS at the client information handling system does correspond to the type of the update to the OS, identifying, from the data store and for each computer-implemented application at the client information handling system, a similar computer-implemented application that is associated with the type of the update to the OS;
creating a unified image including i) the update to the OS and ii) the similar computer-implemented applications;
providing the unified image to the client information handling system; and
applying the unified image at the client information handling system, including installing the new OS at the client information handling system and installing the similar computer-implemented applications at the client information handling system.

17. The computer-implemented method of claim 16, wherein the similar computer-implemented applications are updated versions of the respective computer-implemented applications.

18. The computer-implemented method of claim 16, wherein the equivalent computer-implemented applications are web-based versions of the respective computer-implemented applications.
